(19) United States
(12) Patent Application Publication
(10) Pub. No.: US 2006/0087480 A1
(43) Pub. Date: Apr. 27, 2006

(54) Plasma display device and driving method thereof

(76) Inventors: Tae-Seong Kim, Suwon-si (KR); Woo-Joon Chung, Suwon-si (KR); Jin-Ho Yang, Suwon-si (KR)

Correspondence Address: CHRISTIE, PARKER & HALE, LLP, PO BOX 7068, PASADENA, CA, 91109-7068, US

(21) Appl. No.: 11/253,826

(22) Filed: Oct. 18, 2005

(30) Foreign Application Priority Data
Oct. 25, 2004 (KR) 10-2004-0085249

(51) Int. Cl. G09G 3/28

(52) U.S. Cl. 345/63

(57) ABSTRACT

Disclosed is a plasma display device and driving method thereof. Frames are divided into a set of subfields. A main reset waveform is applied in the first subfield in which non-reference data is applied. An auxiliary reset waveform is applied in other subfields so that address failure caused by loss of wall charges is reduced and low discharges are prevented.

### CROSS-REFERENCE TO RELATED APPLICATION

This application claims priority to and the benefit of Korean Patent Application No. 10-2004-0085249 filed in the Korean Intellectual Property Office on Oct. 25, 2004, the entire content of which is incorporated herein by reference.

### BACKGROUND OF THE INVENTION

(a) Field of the Invention

The present invention relates to a plasma display device including a plasma display panel (PDP), and in particular, to an address driving circuit for applying an address voltage.

(b) Description of the Related Art

A plasma display device is a flat panel display that uses plasma generated by gas discharge to display characters or images. The PDP includes, depending on its size, more than several scores to millions of pixels arranged in a matrix pattern. A frame for driving a plasma display device is divided into a plurality of weighted subfields. Grayscale values are represented by a combination of the subvalues corresponding to each subfield.

Each subfield includes a reset period, an address period, and a sustain period. The reset period is a period in which to initialize the state of each cell such that an addressing operation of each cell can be smoothly performed. The address period is a period in which to apply an address voltage to an addressed cell to accumulate wall charges in the addressed cell in order to select a cell to be turned on or turned off in the PDP. The sustain period is a period in which to apply a sustain discharge pulse to the addressed cell that actually causes the display of images. Reset periods and address periods or equal duration are present in each of the subfields.

U.S. Pat. No. 6,294,875 discloses a selective reset scheme in which a main reset waveform having a rising ramp and a falling ramp is applied to perform a reset operation during a reset period of a first subfield. An auxiliary reset waveform for applying a falling ramp is applied during a reset period of the next subfield. However, a low discharge may occur in lower bits (below the gray scale value of 100) except in the first subfield of the frame if the main reset waveform is applied only during the reset period of the first subfield of the frame. Accordingly, the main reset waveform is consecutively applied to reduce the probability of low discharge during a predetermined subfield of the lower bits. The consecutive application of a main reset waveform, however, diminishes the dark room contrast of the PDP.

### SUMMARY

A plasma display device and a method for driving the plasma display device, which provide the advantage of generating a stable address discharge for low grayscale values. In one embodiment, a plasma display device includes a plurality of first electrodes, second electrodes, and address electrodes. A discharge cell is formed by a first electrode, a second electrode, and an address electrode. The driving method divides a frame into a plurality of weighted subfields. Grayscale values are represented by a combination of subvalues corresponding to the subfields. The method may determine a first subfield in which non-reference data representing a grayscale subvalue is applied. Voltage at the first electrode may be gradually increased and gradually reduced to reset the discharge cell during a reset period of the first subfield. The first subfield may precede other subfields in a first group of subfields. The voltage at the first electrode may be gradually reduced to reset the discharge cell in a reset period of each of a second group of subfields.

Discharge cells that are discharged are subsequently reset during the reset period of the first subfield. A discharge cell that is sustain-discharged during a previous subfield is reset during the reset period of the second group of subfields.

In another embodiment, a plasma display device may include a plasma display panel, a controller, and a driving circuit. The plasma display panel includes a plurality of discharge cells. The controller divides a frame into a plurality of weighted subfields and determines a first subfield in which non-reference data for representing a grayscale subvalue is initially applied. The driving circuit supplies a driving voltage to an electrode of a discharge cell according to a control signal of the controller. The driving circuit resets the discharge cells in the reset period of the first subfield. The first subfield is the first chronologically in a first group of subfields. The driving circuit resets the discharge cells, which had a sustain-discharge in a previous subfield, during the reset period of a second group of subfields.

### BRIEF DESCRIPTION OF THE DRAWINGS

FIG. 1 is a diagram of one embodiment of a plasma display device.

FIG. 2 is a diagram of one embodiment of a driving waveform diagram for a plasma display device.

FIG. 3 is table of example subvalues for respective gray scales corresponding to weighted subfields of a frame for a plasma display device.

FIG. 4 is a diagram of one embodiment of a driving waveform for a plasma display device.

### DETAILED DESCRIPTION

In the following detailed description, exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive. In the drawings, illustrations of elements having no relation with the present invention are omitted in order to more clearly present the subject matter of the present invention. In the specification, the same or similar elements are denoted by the same reference numerals even though they are depicted in different drawings.

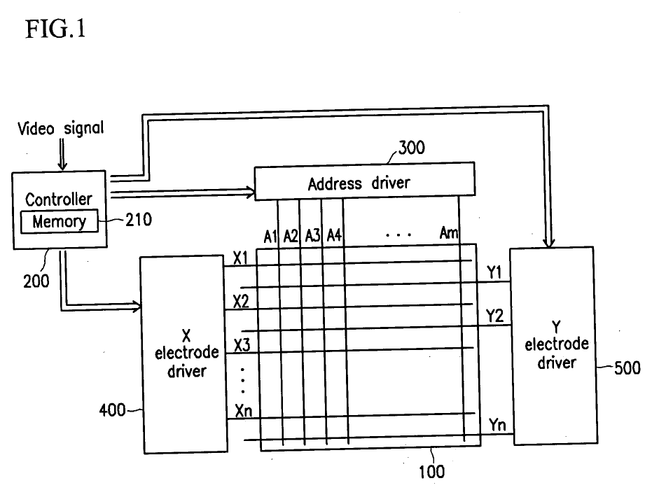

Embodiments of a plasma display device and a driving method thereof are described with reference to drawings. As shown in FIG. 1, the plasma display device includes a plasma display panel 100, a controller 200, an address driver 300, a sustain electrode driver (X electrode driver) 400, and a scan electrode driver (Y electrode driver) 500.

The plasma display panel 100 includes a plurality of address electrodes A1 to Am as columns, and a plurality of sustain electrodes (X electrodes) X1 to Xn and scan electrodes (Y electrodes) Y1 to Yn as rows. The X electrodes X1 to Xn are formed to correspond to the Y electrodes Y1 to Yn, and one terminal of each of the X electrodes X1 to Xn is coupled in common to those of the Y electrodes Y1 to Yn.

The plasma display panel 100 includes a glass substrate (not shown) on which the X and Y electrodes X1 to Xn and Y1 to Yn are arranged, and another glass substrate (not shown) on which the address electrodes A1 to Am are arranged. The two glass substrates face with each other with a discharge space therebetween, so that the Y electrodes Y1 to Yn may cross the address electrodes A1 to Am and the X electrodes X1 to Xn may cross the address electrodes A1 to Am. In this instance, discharge spaces provided at points where the address electrodes A1 to Am cross the X and Y electrodes X1 to Xn and Y1 to Yn form discharge cells.

The controller 200 receives an external image signal, and outputs an address drive control signal, an X electrode drive control signal, and a Y electrode drive control signal. The controller 200 divides a frame of the external image signal into a plurality of subfields and drives these signals to the respective controllers. Each subfield has a reset period, an address period, and a sustain period with respect to time. The address driver 300 receives the address drive control signal from the controller 200, and applies a display data signal for selecting a desired discharge cell to the respective address electrodes A1 to Am. The X electrode driver 400 receives the X electrode drive control signal from the controller 200 and applies a driving voltage to the X electrodes X1 to Xn, and the Y electrode driver 500 receives the Y electrode drive control signal from the controller 200 and applies a driving voltage to the Y electrodes Y1 to Yn.

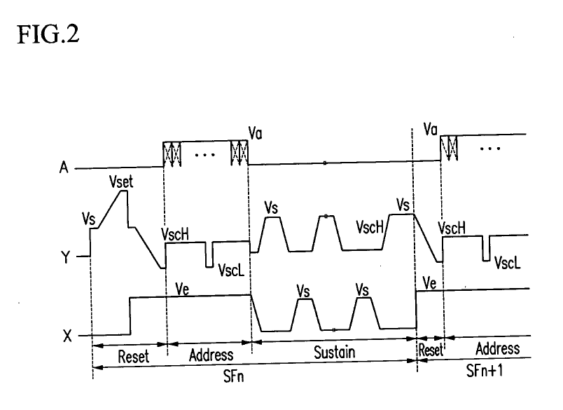

FIG. 2 shows a driving waveform diagram for a plasma display device according to an embodiment of the present invention. As shown in FIG. 2, a main reset waveform that gently rises from the voltage of Vs to the voltage of Vset and gently falls from the voltage of Vs to the voltage of VscL is applied to the Y electrode during a reset period of a subfield SFn after the last sustain pulse is applied in the previous sustain period. A reference voltage of 0V is applied to the address electrode, and the reference voltage of 0V is applied to the X electrode while the rising ramp voltage is applied to the Y electrode. A voltage of Ve is applied to the X electrode when the falling ramp voltage is applied to the Y electrode. When the main reset waveform is applied as described above, a weak discharge occurs from the Y electrode to the address electrode and the X electrode while the rising ramp voltage is applied to the Y electrode. A weak discharge occurs from the address electrode and the X electrode to the Y electrode due to a wall voltage generated in the discharge cell when the falling ramp voltage is applied to the scan electrode, thereby resetting the discharge cells.

During the address period, a positive voltage of Va is applied to an address electrode of a discharge cell to be selected, and the voltage of VscL is applied to the Y electrode. An address discharge occurs between the address electrode and the Y electrode and between the X electrode and the Y electrode because of a wall voltage caused by wall charges in the reset period and the positive voltage of Va. Positive wall charges are accumulated at the Y electrode by the above-noted discharge, and negative wall charges are accumulated at the X and address electrodes by the discharge. A sustain-discharge occurs because of a sustain pulse applied during the sustain period in the selected discharge cells with accumulated wall charges caused by the address discharge.

An auxiliary reset waveform having a falling ramp waveform that decreases from the voltage of Vs to the voltage of VscL is applied to the Y electrode during a reset period of a subfield SFn+1. A weak discharge occurs in a cell in which a sustain discharge occurs in the sustain period of the subfield SFn, thereby resetting the discharge cell. However, when an auxiliary reset waveform is applied in the reset period of the subfield SFn+1, no discharge occurs in the cell in which no sustain discharge occurred during the sustain period of a subfield SFn because the cell maintains the wall charges at the end of the reset period.

The same waveform as that of the subfield SFn is applied in each address period and sustain period. A main reset waveform is applied in the reset period of a subfield during which the first non-reference data (e.g., a grayscale subvalue of 1) is applied and an auxiliary reset waveform is applied in the reset periods of other subfields based on an analysis of grayscale subvalues in the subfield data. The grayscale subvalues in the subfield data are stored in a memory 210 of the controller.

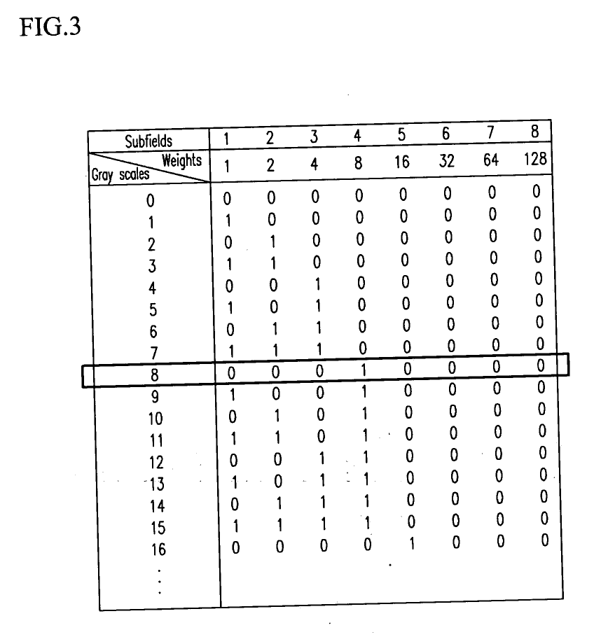

FIG. 3 shows grayscale subvalue data for corresponding weighted subfields for an example representing 256 grayscales values as subvalues in eight subfields with the order of the weights of subfields starting with a low weight given to subfields and ending with a high weight given to subfields. Referring to FIG. 3, grayscale subvalues in each subfield corresponding to a frame are “0” or a similar reference value in the first to third subfields, and the subvalue is “1” or a similar indicator value in the fourth subfield in the example of a grayscale value of 8.

The controller 200 analyzes the grayscale subvalues for each subfield stored in the memory 210 to apply an auxiliary reset waveform in the reset periods of the first to third subfields having the subvalue of “0,” and applies a main reset waveform in the reset period of the fourth subfield having the subvalue of “1.” The controller applies an auxiliary reset waveform in the reset periods of the fifth and subsequent subfields.

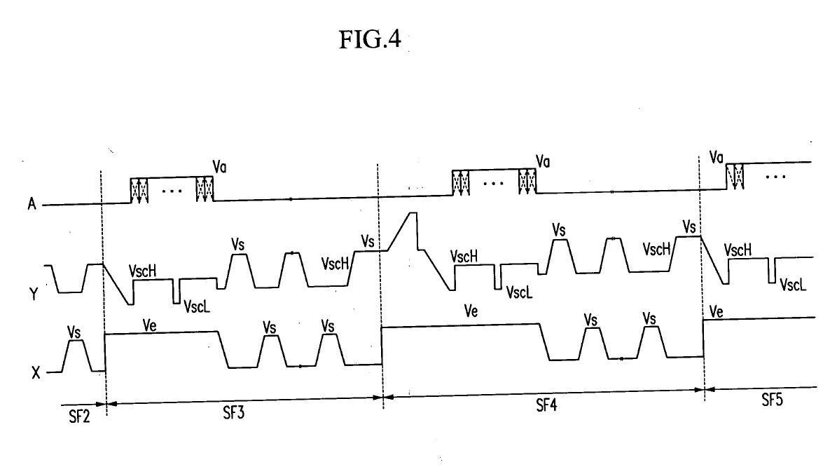

FIG. 4 shows a driving waveform diagram for representing the grayscale value of 8 shown in FIG. 3 according to an embodiment of the present invention. Similarly, when presenting the grayscale value of 16, an auxiliary reset waveform is applied in the reset periods of the first to fourth subfields and a main reset waveform is applied in the reset period of the fifth subfield since the subvalues are “0” in the first to fourth subfields and the subvalues are “1” in the fifth subfield, and an auxiliary reset waveform is then applied in the reset periods of the sixth and subsequent subfields.

Accordingly, the main reset waveform is applied in the subfield in which non-reference data is first applied, and it is then possible to control the wall voltage according to an address condition after the wall charges are accumulated at the Y electrode in the reset period. Therefore, the low discharge caused by loss of wall charges at the Y electrode may not occur in the address period, and degradation of dark room contrast is reduced, which is caused by applying the main reset waveform to a plurality of subfields many times.

The exemplary embodiment of presenting one grayscale value on one screen has been described and the method is also applicable to the case of presenting at least two grayscale values on the screen. In this example, the embodiment is executed with reference to the grayscale value with a higher percentage of occupation of the screen.

For example, the grayscales values of 8 and 9 may be concurrently displayed on a screen and their occupation percentages (e.g., the amount of the screen covered by each grayscale value) may be 90% and 10%, respectively. Referring to FIG. 3, the grayscale subvalues of the first to third subfields are “0” and the subvalues of the fourth subfield is “1” for the grayscale value of 8, whereas the subvalue is a “1” in the first subfield for the grayscale value of 9. The main reset waveform is applied with reference to the subvalues in each subfield for the grayscale value of 8, because the occupation percentage of the grayscale value of 8 is 90% and that of the grayscale value of 9 is 10%. That is, an auxiliary reset waveform is applied in the reset periods of the first to third subfields, and a main reset waveform is applied in the reset period of the fourth subfield. In this instance, a low discharge may occur, because of an application of an auxiliary reset waveform, in the first subfield for representing the grayscale value of 9, but the low discharge is ignorable because the percentage of screen occupied by the grayscale value of 9 is less than that occupied by the grayscale value of 8.

Also, the subvalue data for respective grayscales values may be analyzed to apply the main reset waveform to different subfields, and in addition, the subfields can be divided into a first group for applying the main reset and a second group for applying the auxiliary reset in another exemplary embodiment, and in this instance, the initial subfield in the first group represents a subfield in which non-reference data is first applied.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the present invention, the subfields to which the main reset waveform is applied are differentiated according to grayscale subvalues in each subfield, thereby reducing address failure caused by loss of wall charges and preventing low discharges.

What is claimed is:

1. A method for driving a plasma display device including a plurality of first electrodes, a plurality of second electrodes, and a plurality of address electrodes, wherein a discharge cell is formed by a first electrode, a second electrode, and an address electrode, the method including dividing a frame into a plurality of weighted subfields and representing grayscale values through a combination of grayscale subvalues in the subfields, the method comprising:
determining a first subfield in which non-reference data for representing the grayscale value is initially applied;
gradually increasing a voltage at the first electrode and gradually reducing the voltage at the first electrode to reset the discharge cell during a reset period of the first subfield, the first subfield being the first chronologically from among a first group of subfields; and
gradually reducing the voltage at the first electrode to reset the discharge cell during a reset period of a second group of subfields.

2. The method of claim 1, wherein the voltage at the first electrode is gradually reduced to reset the discharge cell during reset periods of each subfield in the first group of subfields except the first subfield.

3. The method of claim 1, wherein the voltage at the first electrode is gradually increased and is then gradually reduced to reset the discharge cell during reset periods of each subfield in the first group of subfields except the first subfield.

4. The method of claim 1, wherein discharge cells are discharged to be reset during the reset period of the first subfield, and a discharge cell that is sustain-discharged in a previous subfield is reset during the reset period of the second group of subfields.

5. The method of claim 1, wherein a voltage difference between the first electrode and the second electrode and a voltage difference between the first electrode and the address electrode are respectively increased and reduced during the reset period of the first subfield when the voltage at the first electrode is gradually increased and is then gradually reduced, and
wherein the voltage difference between the first electrode and the second electrode and the voltage difference between the first electrode and the address electrode are respectively reduced during the reset periods of the second group of subfields when the voltage at the first electrode is gradually reduced.

6. The method of claim 1, wherein the voltage at the first electrode is gradually increased from a first voltage to a second voltage and is gradually reduced from a third voltage to a fourth voltage in the reset period of the first subfield, and the voltage at the first electrode is gradually reduced from a fifth voltage to the fourth voltage in the reset period of the second group of subfields.

7. The method of claim 1, further comprising:
determining screen occupation percentage for a first grayscale value and a second grayscale value.

8. The method of 7, further comprising:
gradually increasing the voltage at the first electrode and gradually reducing the voltage at the first electrode to reset the discharge cell during a reset period of the first subfield corresponding to the first grayscale value, if the first grayscale value has a greater screen occupation percentage than the second grayscale value.

9. The method of claim 1, further comprising:
storing grayscale subvalues in a storage device.

10. The method of claim 9, further comprising:
processing the grayscale subvalues by a controller to determine the first subfield.

11. A plasma display device comprising:
a plasma display panel including a plurality of discharge cells;
a controller for dividing a frame into a plurality of weighted subfields and determining a first subfield in which non-reference data for representing a grayscale value is initially applied; and
a driving circuit for supplying a driving voltage to an electrode at a discharge cell according to a control signal of the controller,
wherein the driving circuit resets the discharge cell during the reset period of the first subfield, the first subfield being chronologically first in a first group of subfields, and
wherein the driving circuit resets the discharge cell that is sustain-discharged in a previous subfield during the reset period of a second group of subfields.

12. The plasma display device of claim 11, further comprising a memory for storing grayscale subvalue data.

13. The plasma display device of claim 11, wherein the driving circuit resets the discharge cell during reset periods of the first group of subfields except during the first subfield.

14. The plasma display device of claim 11, wherein the driving circuit resets the discharge cell that is sustain-discharged in a previous subfield during the reset periods of the first group of subfields except during the first subfield.

15. The plasma display device of claim 11, wherein the driving circuit gradually increases a voltage difference of two electrodes forming the discharge cell and then gradually reduces the voltage difference to reset the discharge cell, and
wherein the driving, circuit gradually reduces a voltage difference of two electrodes forming the discharge cell to reset the discharge cell that is sustain-discharged in the previous subfield.

16. The plasma display device of claim 11, wherein the controller accesses grayscale subvalue data in the memory to determine the first subfield.

17. The plasma display device of claim 11, wherein the controller determines screen occupation percentage for a first grayscale value and a second grayscale value to be displayed concurrently.

18. The plasma display device of claim 17, wherein the controller determines the first subfield for the first grayscale value if the first grayscale value has a greater screen occupation percentage than the second grayscale value.

19. The plasma display device of claim 11, wherein the driving circuitry includes an address driver, an X electrode driver and a Y electrode driver.

20. The plasma display device of claim 11, wherein the controller generates separate control signals for each of the address driver, X electrode driver and Y electrode driver.
